(19) United States
(12) Patent Application Publication
(10) Pub. No.: US 2017/0029992 A1
(43) Pub. Date: Feb. 2, 2017

(54) FLOCCULAR COTTON THERMAL INSULATION AND METHOD FOR PREPARATION THEREOF

(71) Applicant: DABUS CO., LTD., Taipei City (TW)

(72) Inventors: Larry Shih, Taipei City (TW); Ming-Kuang Ho, Taipei City (TW)

(21) Appl. No.: 15/205,071

(22) Filed: Jul. 8, 2016

(30) Foreign Application Priority Data
Jul. 30, 2015 (TW) 104124810

(51) Int. Cl. D04H 1/58; D04H 1/02; F16L 59/02; D04H 13/00

(52) U.S. Cl. CPC D04H 1/58; D04H 13/00; D04H 1/02; F16L 59/02

(57) ABSTRACT

Provided is a method for preparation of a floccular cotton thermal insulation, comprising steps of preparing a material comprising floccular cotton; conveying the material through a dispersion device; dispersing the material conveyed through the dispersion device between a first cloth and a second cloth of a transportation device; pressing the material located between the first cloth and the second cloth by two pressing devices for the first cloth and the second cloth to attach to each other to form a combination; and fusing the combination by a fusion device to obtain a floccular cotton thermal insulation. The method for preparation of a floccular cotton thermal insulation uses a dispersion device, such that the material can be equally dispersed in the floccular cotton thermal insulation to maintain fluffiness for keeping warm.

### CROSS REFERENCE

This application claims priority to TW Patent Application Serial No. 104124810, filed on Jul. 30, 2015, the content of which is hereby incorporated by reference in its entirety.

### BACKGROUND OF THE INVENTION

1. Field of the Invention

The present invention relates to a method for preparation, particularly to a method for preparation of floccular cotton thermal insulation. The present invention also relates to a floccular cotton thermal insulation, particularly to a floccular cotton thermal insulation produced by the above method.

2. Description of the Prior Arts

Feathers having properties of lightweight and thermal insulation are used for processing into down jackets, duvets, or sleeping bags, etc. for the user to wear or cover to keep warm. Although the down has thermal insulation property, the obtaining of down is usually done by pulling down feathers directly from the birds and involves inhumanity. Therefore, artificial fibers or polyethylene fibers are developed to replace the down.

Artificial fibers or polyethylene fibers are woven to form a net by filamentous weave in the prior arts, and the net can be stacked layer by layer to increase the thickness for resembling the warmness of down and then to obtain an artificial product. Although the net preparation from artificial fibers or polyethylene fibers by filamentous weave can increase the thickness, the pores or gaps within the artificial product are insufficient if the gaps or pores of the artificial product are too small such that the user wears the clothes made by the artificial product cannot store the heat produced by the user's body for keeping warm.

Therefore, the disadvantages in prior arts of developing the artificial product and the preparation method thereof to replace the down should be resolved.

### SUMMARY OF THE INVENTION

According to the above description, the objective of the present invention is to provide a method for preparation of floccular cotton thermal insulation by the dispersion device to equally disperse the material; the objective of the present invention is also to provide a floccular cotton thermal insulation produced by the above method to store the air effectively.

To achieve the above purpose of the present invention, the objective of the invention is to provide a method for preparation of floccular cotton thermal insulation, comprising steps of preparing a material comprising floccular cotton; conveying the material through a dispersion device; dispersing the material conveyed through the dispersion device between a first cloth and a second cloth of a transportation device; pressing the material located between the first cloth and the second cloth by two pressing devices, and the first cloth and the second cloth attached to each other to form a combination; and fusing the combination by a fusion device to obtain a floccular cotton thermal insulation.

Preferably, the dispersion device is an upright duct, and a wall of the upright duct reciprocates toward and away from the center of the upright duct for dispersedly dropping the material down to the transportation device.

Preferably, the two pressing devices are respectively mounted at a top end and a bottom end of the transportation device.

Preferably, the fusion device is an ultrasonic fusion device, and the fusion device comprises a fusion base and a heater. The fusion base is located at the top end of the transportation device; the heater is located at the bottom end of the transportation device and is opposite the fusion base.

More preferably, the first cloth and the second cloth are both non-woven clothes.

In another aspect, the present invention relates to a floccular cotton thermal insulation produced by the above method.

The advantages of the present invention is that the method for preparing floccular cotton thermal insulation of the present invention uses a dispersion device, such that the material can be equally dispersed in the floccular cotton thermal insulation to maintain fluffiness for keeping warm.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a weaving equipment used for a method for preparation of a floccular cotton thermal insulation of the present invention;

FIG. 2 is a flow chart illustrating the method for preparation of the floccular cotton thermal insulation of the present invention; S1 to S5 stand for step 1 to step 5;

FIG. 3 is a perspective view of a floccular cotton thermal insulation produced by the method for preparation of the floccular cotton thermal insulation of the present invention

### DETAILED DESCRIPTION OF THE PREFERRED EMBODIMENTS

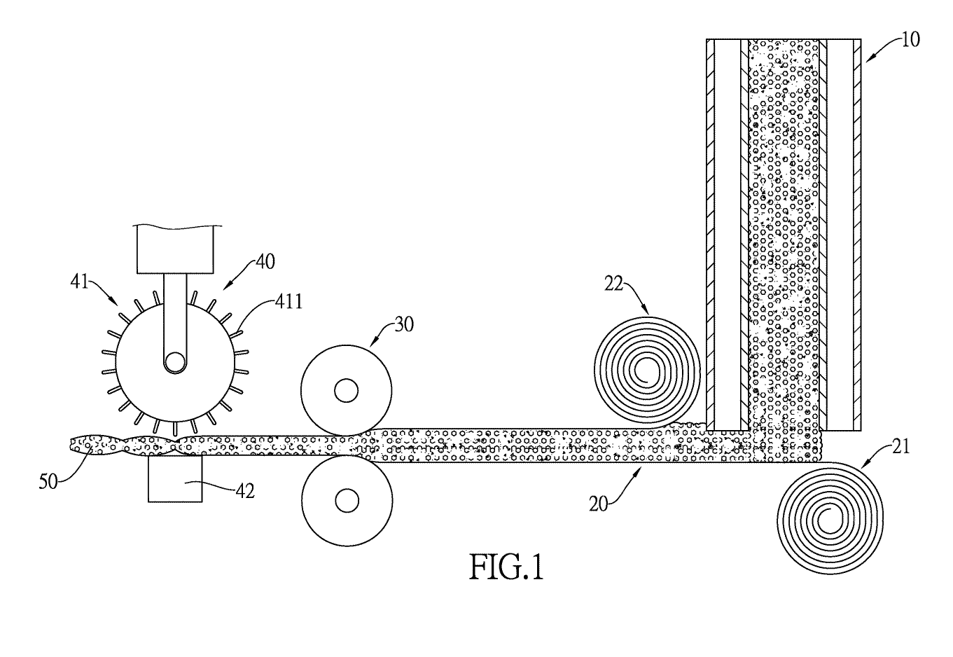

As shown in FIG. 1, a weaving equipment used for the method for preparation of a floccular cotton thermal insulation of the present invention comprises a dispersion device 10, a transportation device 20, two pressing devices 30, and a fusion device 40. The dispersion device 10 is an upright duct, and a bottom of the dispersion device 10 is adjacent to a front end of the transportation device 20. A wall of the upright duct reciprocates toward and away from the center of the upright duct. The transportation device 20 is a conveyor, comprising a first unwinding cylinder 21 and a second unwinding cylinder 22, wherein the first unwinding cylinder 21 is located at a top end of the front end of the transportation device 20, and the second unwinding cylinder 22 is located at a bottom end of the front end of the transportation device 20. The first unwinding cylinder 21 opposite the dispersion device 10 rolls up a first cloth, and the second unwinding cylinder 22 adjacent to the dispersion device 10 rolls up a second cloth. The first cloth is along a top surface of the transportation device 20, and the second cloth is along a bottom surface of the transportation device 20. The first cloth and the second cloth are both non-woven cloth. The two pressing devices 30 are located between the front end and a rear end of the transportation device 20, and the two pressing devices 30 are opposite each other and are respectively located at a top end and a bottom end of the transportation device 20. The fusion device 40 is an ultrasonic fusion device, and the fusion device 40 is located at the rear end of the transportation device 20. The fusion device 40 comprises a fusion base 41 and a heater 42, wherein the fusion base 41 located at the top end of the transportation device 20 comprises multiple fusion needles 411, and the heater 42 located at the bottom end of the transportation device 20 is opposite the fusion base 41.

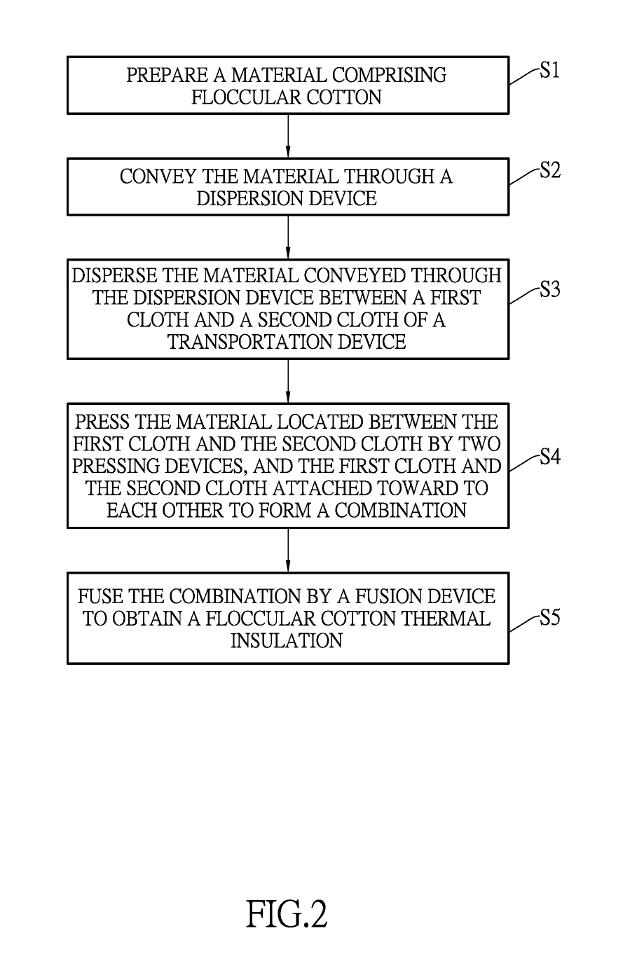

As shown in FIG. 1 and FIG. 2, the above weaving equipment is used for the method for preparation of a floccular cotton thermal insulation of the present invention. The method comprises the following steps: (S1) preparing a material comprising floccular cotton; in the preferred embodiment, the material includes, but is not limited to polyethylene (PE), polypropylene (PP), polystyrene (PS), polymethylmethacrylate (PMMA), polyvinyl chloride (PVC), nylon, polycarbonate (PC), polyurethane (PU) polytetrafluoroethylene (PTFE), polyethylene terephthalate (PET), polyoxymethylene (POM) or any combination thereof The material is placed at a top end of the dispersion device 10, and with the wall of the upright duct reciprocating toward and away from the center of the upright duct, the material is dropped dispersedly from the top end of the dispersion device 10 down to a bottom end of the dispersion device 10 and dropped onto the bottom surface of the front end of the transportation device 20 adjacent to the bottom end of the dispersion device 10 (S2). The first unwinding cylinder 21 located at the bottom end of the transportation device 20 has the first cloth, and the second unwinding cylinder 22 located at the top end of the transportation device 20 has the second cloth. When the material is moved away from the dispersion device 10, the material is located between the first cloth and the second cloth (S3). The material is transported from the front end to the rear end of the transportation device 20, and is through the two pressing devices 30 respectively located between the rear end and the front end of the transportation device 20, such that the first cloth and the second cloth are attached to each other to form a combination (S4). The combination conveyed to the fusion device 40 located at the rear end of the transportation device 20 is fused to obtain a floccular cotton thermal insulation 50 (S5).

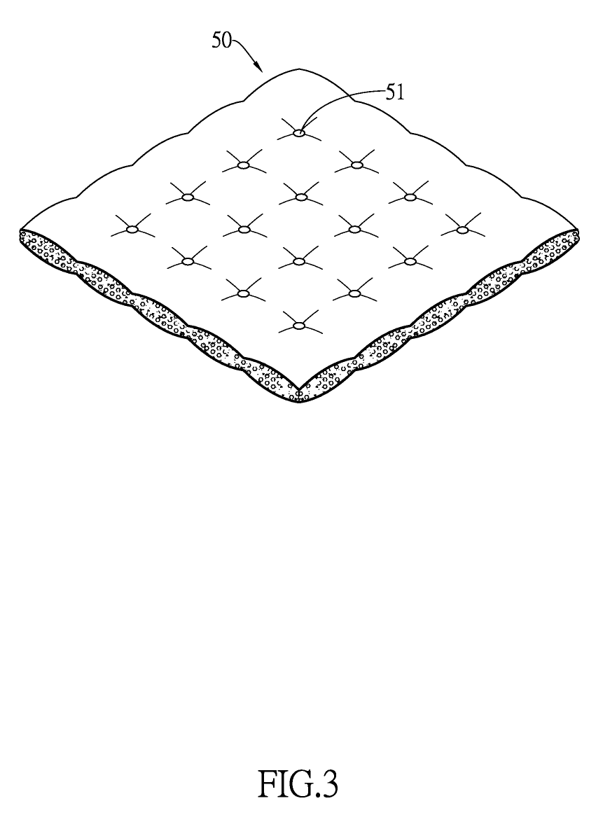

As shown in FIG. 1 and FIG. 3, the floccular cotton thermal insulation 50 is obtained from the material by the method for preparation of the floccular cotton thermal insulation through the above weaving equipment. The floccular cotton thermal insulation 50 has multiple materials sandwiched between the first cloth and the second cloth, and the materials are formed in a small and floccular shape. The floccular cotton thermal insulation 50 with fusion points 51 are fused by the heater 42 and the fusion needles 411 of the fusion base 41 of the fusion device 40, such that the inside of the floccular cotton thermal insulation 50 can maintain fluffiness to store air for keeping warm.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for preparation of a floccular cotton thermal insulation, comprising steps of:
preparing a material comprising floccular cotton;
conveying the material through a dispersion device;
dispersing the material conveyed through the dispersion device between a first cloth and a second cloth of a transportation device;
pressing the material located between the first cloth and the second cloth by two pressing devices, and the first cloth and the second cloth attached to each other to form a combination; and
fusing the combination by a fusion device to obtain a floccular cotton thermal insulation.

2. The method as claimed in claim 1, wherein the dispersion device is an upright duct, and a wall of the upright duct reciprocates toward and away from the center of the upright duct for dispersedly dropping the material down to the transportation device.

3. The method as claimed in claim 1, wherein the two pressing devices are respectively mounted at a top end and a bottom end of the transportation device.

4. The method as claimed in claim 1, wherein the fusion device is an ultrasonic fusion device, and the fusion device comprises:
a fusion base located at a top end of the transportation device; and
a heater located at a bottom end of the transportation device and opposite the fusion base.

5. The method as claimed in claim 2, wherein the fusion device is an ultrasonic fusion device, and the fusion device comprises:
a fusion base located at a top end of the transportation device; and
a heater located at a bottom end of the transportation device and opposite the fusion base.

6. The method as claimed in claim 3, wherein the fusion device is an ultrasonic fusion device, and the fusion device comprises:
a fusion base located at the top end of the transportation device; and
a heater located at the bottom end of the transportation device and opposite the fusion base.

7. The method as claimed in claim 4, wherein the first cloth and the second cloth are both non-woven clothes.

8. The method as claimed in claim 5, wherein the first cloth and the second cloth are both non-woven clothes.

9. The method as claimed in claim 6, wherein the first cloth and the second cloth are both non-woven clothes.

10. A floccular cotton thermal insulation produced by the method as claimed in claim 1.
